(19) United States
(12) Patent Application Publication
(10) Pub. No.: US 2009/0141655 A1
(43) Pub. Date: Jun. 4, 2009

(54) SYSTEM AND METHOD FOR MONITORING HEAD END CABLE MODEM IN CABLE NETWORK

(76) Inventors: TaeKyoon Kim, Daejeon (KR); O Hyung Kwon, Daejeon (KR); Soo In Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/234,754

(22) Filed: Sep. 22, 2008

(30) Foreign Application Priority Data
Dec. 4, 2007 (KR) 10-2007-0125152

(51) Int. Cl. H04L 12/28

(52) U.S. Cl. 370/254

(57) ABSTRACT

Disclosed are a system and method for monitoring a headend cable modem on a digital cable network, which may monitor a headend cable modem using a configuration management message capable of controlling the headend cable modem. The system includes a message header unit for monitoring the headend cable modem by exchanging a configuration management message including configuration information for controlling channel boding of the headend cable modem and state information of the configuration information with the headend cable modem; and a message varying unit including the configuration information corresponding to the message type information and the state information.

### CROSS-REFERENCE TO RELATED APPLICATION

This application claims the benefit of Korean Patent Application No. 10-2007-0125152, filed on Dec. 4, 2007, in the Korean Intellectual Property Office, the entire disclosure of which is incorporated herein by reference.

### BACKGROUND OF THE INVENTION

1. Field of the Invention

The present invention relates to a system and method for monitoring a headend cable modem on a digital cable network, and more particularly, to a system and method for monitoring a headend cable modem on a digital cable network, which may monitor a headend cable modem using a configuration management message capable of controlling the headend cable modem.

This work was supported by the IT R&D program of MIC/IITA. [2006-S-019-02, Development of Digital Cable Transmission and Receive System for 1 Gbps Downstream]

2. Description of Related Art

In a version prior to a Data Over Cable Service Interface Specifications (DOCSIS) 3.0 of a cable network, configuration information associated with channel bonding may not need to be managed in order to control and manage a headend cable modem because the version does not include information associated with the channel bonding. However, in a headend cable modem under the DOCSIS 3.0 using a channel-bonding scheme, the information associated with the channel bonding has become an essential element in the configuration information.

Specifically, essential elements for all-Internet Protocol (ALL-IP) based on wideband in the cable network may be defined in the DOCSIS 3.0, and expansion of an upstream/downstream bandwidth is one of the essential elements.

FIG. 1 is a schematic diagram illustrating channel bonding used in DOCSIS 3.0.

Referring to FIG. 1, according to existing DOCSIS 2.0, services corresponding to downstream maximum 42 Mbps and upstream maximum 30 Mbps have been supported using a signal upstream and downstream channel. However, according to the DOCSIS 3.0, a modem may combine each of a plurality of channels with one another and simultaneously use the plurality of channels, thereby enabling bandwidth expansion, and being realized based on a minimum of four bonded channels for each of the upstream and downstream channels.

Also, the downstream channel may increase its bandwidth corresponding to approximately 42 Mbps*N channels and the upstream channel may increase its bandwidth corresponding to approximately 30 Mbps*N channels by increasing a number of bonded channels.

In this regard, a mechanism for data distributive transmission and data recombination with respect to each of the bonded channels is needed, which is required to support channel bonding and control and manage configuration information for a maximum number of bonded channels of the headend cable modem and a flow thereof by means of the channel bonding scheme.

Specifically, a new management message for effectively controlling and monitoring the headend cable modem on a digital cable network of the DOCSIS 3.0 using the channel bonding scheme is required to be defined, and accordingly, there arises a need for a system for monitoring the headed cable modem using the management message.

### SUMMARY OF THE INVENTION

An aspect of the present invention provides a configuration of a new configuration management message which may control and manage a headend cable modem of a cable network, and manage configuration information for a maximum number of bonded channels of a channel bonding scheme and a flow thereof.

An aspect of the present invention provides a system for monitoring a cable modem which may determine configuration information of the headend cable modem using the new configuration management message, and inquire state information.

According to an aspect of the present invention, there is provided a system for monitoring a headend cable modem on a cable network, the system including: a message header unit for monitoring the headend cable modem by exchanging a configuration management message including configuration information for controlling channel boding of the headend cable modem and state information of the configuration information with the headend cable modem, the configuration management message including message type information of the configuration management message; and a message varying unit including the configuration information corresponding to the message type information and the state information.

According to an aspect of the present invention, there is a method for monitoring a headend cable modem on a cable network, the method including: generating a configuration management message including configuration information for controlling channel bonding of the headend cable modem or state information of the configuration information; and transmitting the configuration management message to the headend cable modem, and receiving, from the headend cable modem, the configuration management message including response information about the configuration management message, wherein the configuration management message includes: a message header unit to include message type information of the configuration management message; and a message varying unit to include the configuration information and the state information corresponding to the message type information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a schematic diagram illustrating channel bonding used in Data Over Cable Service Interface Specifications (DOCSIS) 3.0;

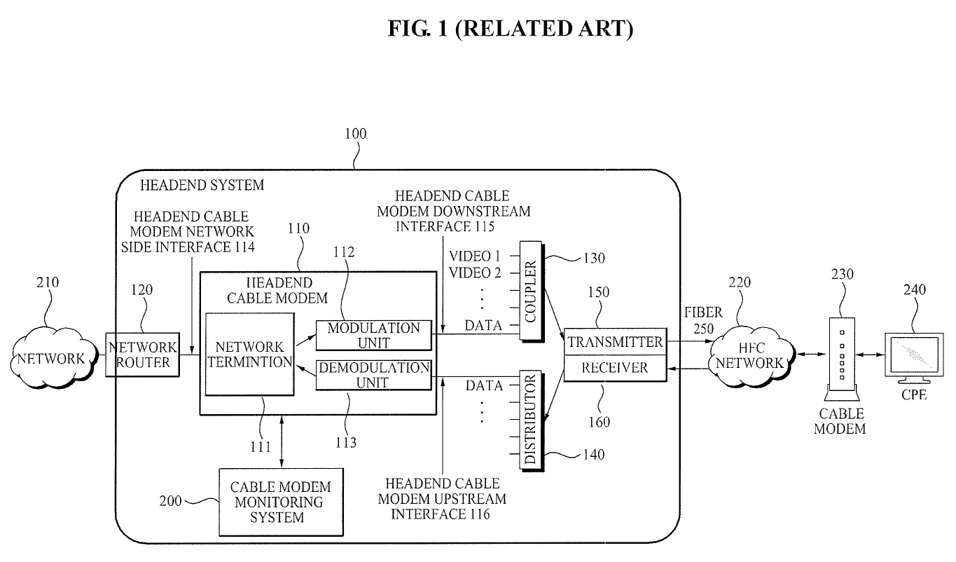

FIG. 2 is a block diagram illustrating a configuration of a DOCSIS transmission system on a cable network supporting a channel bonding scheme and including a system for monitoring a cable modem according to an exemplary embodiment of the present invention;

FIG. 3 is a diagram illustrating a configuration of a configuration management message exchanged between a system for monitoring a headend cable modem on a cable network according to an exemplary embodiment of the invention and the headend cable modem;

FIG. 4 is a diagram illustrating information composing a message header unit included in a configuration management message according to an exemplary embodiment of the present invention;

FIG. 5 is a diagram illustrating information composing a message varying unit included in a configuration management message according to an exemplary embodiment of the present invention;

FIG. 6 is a diagram illustrating a configuration of configuration information according to an exemplary embodiment of the present invention;

FIG. 7 is a flowchart illustrating a method for monitoring a headend cable modem on a cable network according to an exemplary embodiment of the present invention; and

FIG. 8 is a flowchart illustrating a process where a configuration management message is exchanged between a headend cable modem monitoring system according to an exemplary embodiment of the present invention and the headend cable modem.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

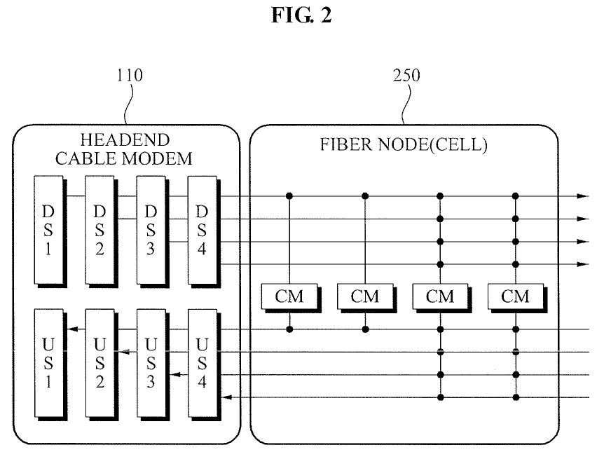

FIG. 2 is a block diagram illustrating a configuration of a Data Over Cable Service Interface Specifications (DOCSIS) transmission system on a cable network supporting a channel bonding scheme and including a system for monitoring a cable modem according to an exemplary embodiment of the present invention.

Referring to FIG. 2, the DOCSIS transmission system on the cable network of the present exemplary embodiment of the invention includes a headend system 100, and a Customer Premise Equipment (CPE) 240 connected via a cable modem 230 using a Hybrid Fiber Coax (HFC) cable network 220. The headend system 100 may transmit audio/video sources and data signals, which are received via an Internet network 210 and a network router 120, to the CPE 240 via a predetermined coupler 130 and a transmitter 150 in a downstream channel bonding scheme using the headend cable modem 110. Also, the headend system 100 may receive, from the CPE 240, data via the cable modem 230 and the HFC cable network 220 and then via a receiver 160 of the headend system 110 and a distributor 140 in an upstream channel bonding scheme. In this case, the headend cable modem 110 may transmit and receive data signals via a predetermined downstream Radio Frequency (RF) interface unit 115, and upstream RF interface unit 116 in the channel bonding scheme.

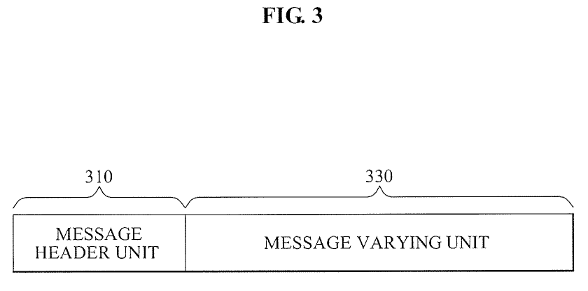

The headend system 100 of the present exemplary embodiment of the invention may support transmission/receiving of the channel bonding scheme of the headend cable modem 110, and include a cable modem monitoring system 200 for monitoring a headend cable modem 110 by exchanging configuration information for controlling channel bonding of the headend cable modem 110 and/or configuration management message with the headend cable modem 110. Also, the cable network may be DOCSIS 3.0 network. The configuration information for controlling the channel bonding of the headend cable modem 100, and/or configuration management message including state information of the configuration information will be described in detail with reference to FIGS. 3 to 5.

FIG. 3 is a diagram illustrating a configuration of a configuration management message exchanged between a system for monitoring a headend cable modem on a cable network according to an exemplary embodiment of the invention and the headend cable modem.

Referring to FIG. 3, the configuration management message of the present exemplary embodiment of the invention may include a message header unit 310, and a message varying unit 330.

The message header unit 310 may include message type information of the configuration management message including 8-bytes, and the message varying unit 330 may include configuration information and/or state information corresponding to the message type information. The message type information may include configuration information determining request information for controlling the configuration information, or configuration information determining response information with respect to determination response of the configuration information corresponding to the configuration information determining request information. Also, the message type information may include configuration information inquiry request information for requesting inquiry of the state information with respect to the headend cable modem, or configuration information inquiry response information with respect to an inquiry response corresponding to the configuration information inquiry request information. Hereinafter, the message header unit 310 composing the configuration management message and the message varying unit 330 will be described in detail.

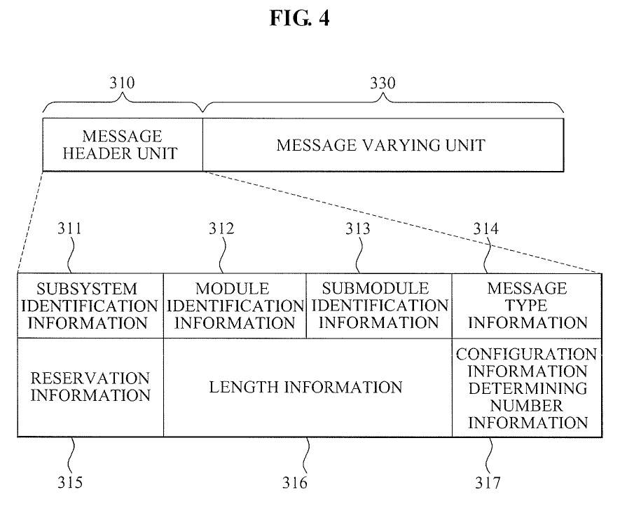

FIG. 4 is a diagram illustrating information composing a message header unit included in a configuration management message according to an exemplary embodiment of the present invention.

The message header unit 310 of the present exemplary embodiment of the invention may include subsystem identification information 311, module identification information 312, submodule identification information 313, message type information 314, reservation information 315, length information 316, or configuration information determining number information 317.

The subsystem identification information 311 may include information for identifying the headend cable modem, the module identification information 312 may include information for identifying modules enabled to be included in the headend cable modem, and the submodule identification information 313 may include information for identifying whether the module is either a downstream modulation module or an upstream demodulation module.

The message type information 314 may include configuration information inquiry request information for requesting inquiry of the state information with respect to the headend cable modem, or configuration information inquiry response information with respect to an inquiry response corresponding to the configuration information inquiry request information.

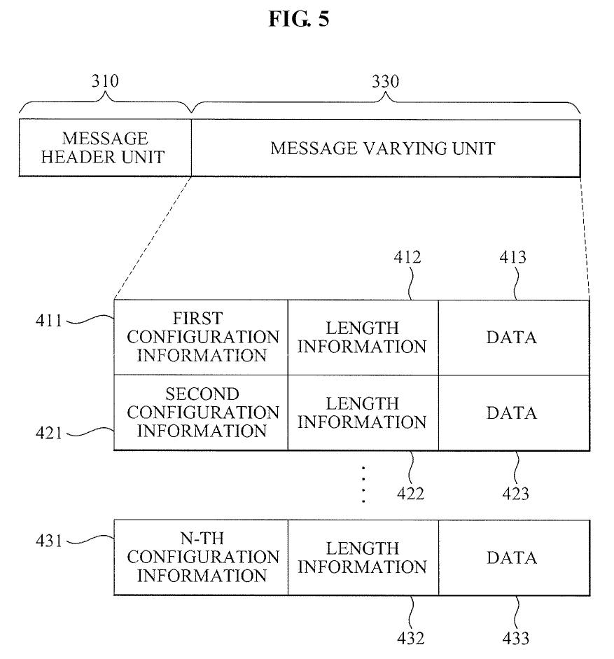

The configuration information determining number information 317 may include information about a number of the determination information of the configuration information included in the message varying unit 330, and the message varying unit 330 may include data corresponding to the configuration information according to the configuration information determining number information 317. The message varying unit 330 will be described in detail with reference to FIG. 5.

FIG. 5 is a diagram illustrating information composing a message varying unit included in a configuration management message according to an exemplary embodiment of the present invention.

Referring to FIG. 5, the message varying unit 330 of the present exemplary embodiment of the invention may include configuration information 411, 421, and 431 according to the configuration information determining number information 317, length information 412, 422, and 432 and data 413, 423, and 433 each corresponding to the configuration information 411, 421, 431.

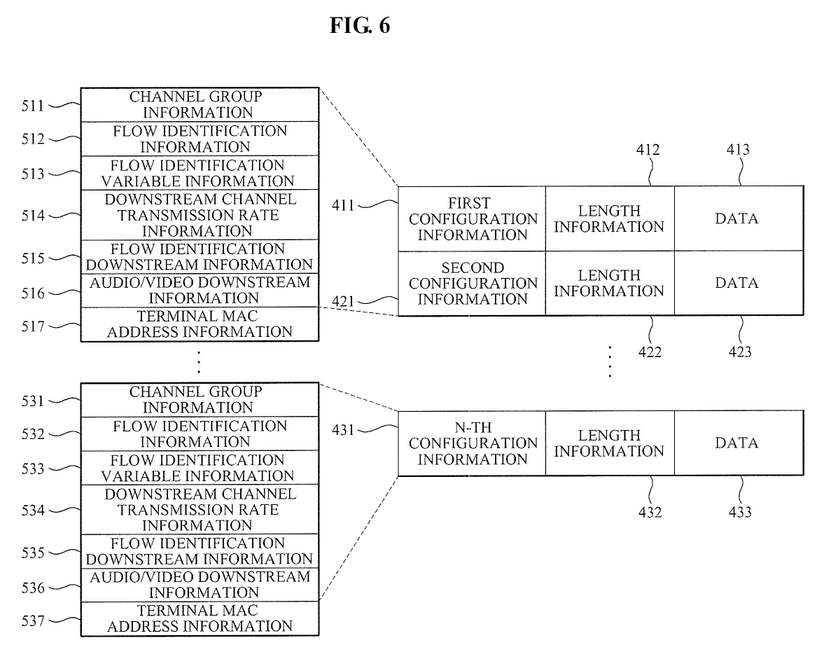

The configuration information 411, 421, and 431 will be described in detail with reference to FIG. 6. FIG. 6 is a diagram illustrating a configuration of configuration information according to an exemplary embodiment of the present invention.

Referring to FIG. 6, the configuration information 411, 421, and 431 may include channel group information 511 and 531 about a number of channels of a channel group enabling channel bonding of the headend cable modem, flow identification information 512 about a flow identifier for identifying a channel of the channel group, and flow identification variable information about a variable for classifying the channel group.

The headend cable modem may receive the configuration management message, to thereby generate data where channel bonding is performed to be transmitted, and map a table index with respect to the data and flow identifier. Also, the headend cable modem may receive the configuration management message, and update an index table with respect to the flow identifier.

Also, the configuration information 411, 421, and 431 may further include downstream channel transmission rate information 514 and 534 with respect to transmission rate determination of the downstream channel, flow identification downstream information 515 and 536 with respect to a channel through which a packet corresponding to the flow identifier for identifying the channel of the channel group of the headend cable modem is outputted, or audio/video downstream information 516 and 536 with respect to channel information of a data stream where audio/video data is multiplexed.

Also, the configuration information 411, 421, and 431 of the present exemplary embodiment of the present invention may further include Media Access Control (MAC) address information 517 and 537 with respect to an MAC address of the CPE 240.

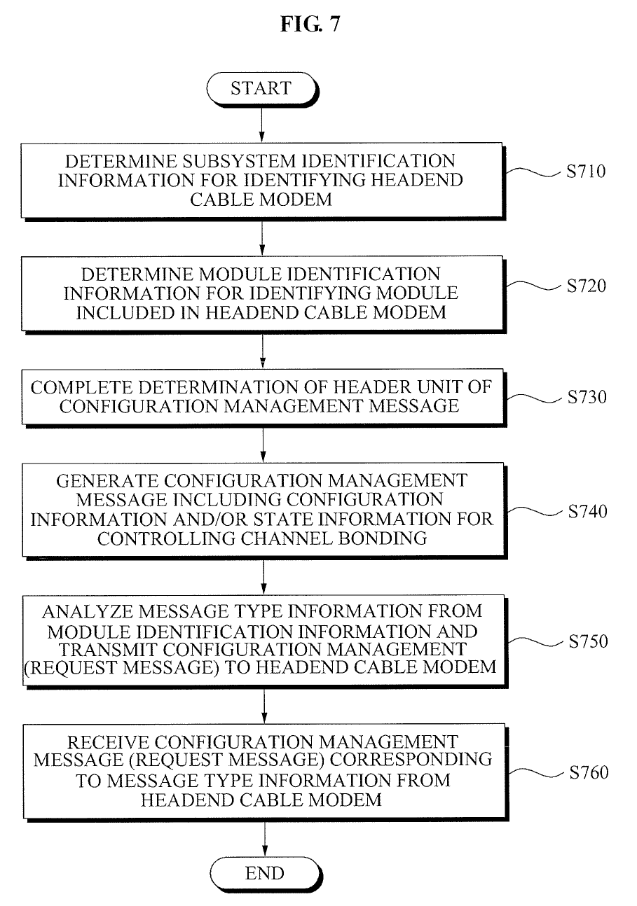

FIG. 7 is a flowchart illustrating a method for monitoring a headend cable modem on a cable network according to an exemplary embodiment of the present invention.

Referring to FIG. 7, the cable modem monitoring system determines subsystem identification information for identifying the headend cable modem in operation S710, and determines module identification information for identifying a module.

Next, in operations S730 and S740, the cable modem monitoring system completes determination of the message header unit of the configuration management message, and generates the configuration management message including configuration information for controlling channel boding of the headend cable modem and/or state information of the configuration information. As described above, the configuration management message includes the message header unit including message type information of the configuration management message, and a message varying unit including the configuration information and/or the state information corresponding to the message type information. The message header unit may include subsystem identification information for identifying the headend cable modem, module identification information for identifying a module included in the headend cable modem, and submodule identification information for identifying a downstream modulation module or an upstream demodulation module when the module is either the downstream modulation module or the upstream demodulation module.

Next, the cable modem monitoring system transmits the configuration management message to the headend cable modem, and receives, from the headend cable modem, the configuration management message including response information with respect to the configuration management message. Specifically, in operation S 750, the cable modem monitoring system may analyze the message type information from the determined module identification information, and transmit the configuration management message corresponding to the message type information to the headend cable modem. In operation S760, the cable modem monitoring system may receive, from the headend cable modem, the configuration management message corresponding to the message type information.

Also, the message type information as described above may include configuration information determining request information for controlling the configuration information, configuration information determining response information with respect to determination response of the configuration information corresponding to the configuration information determining request information, configuration information inquiry request information for requesting inquiry of the state information with respect to the headend cable modem, and configuration information inquiry response information with respect to an inquiry response corresponding to the configuration information inquiry request information.

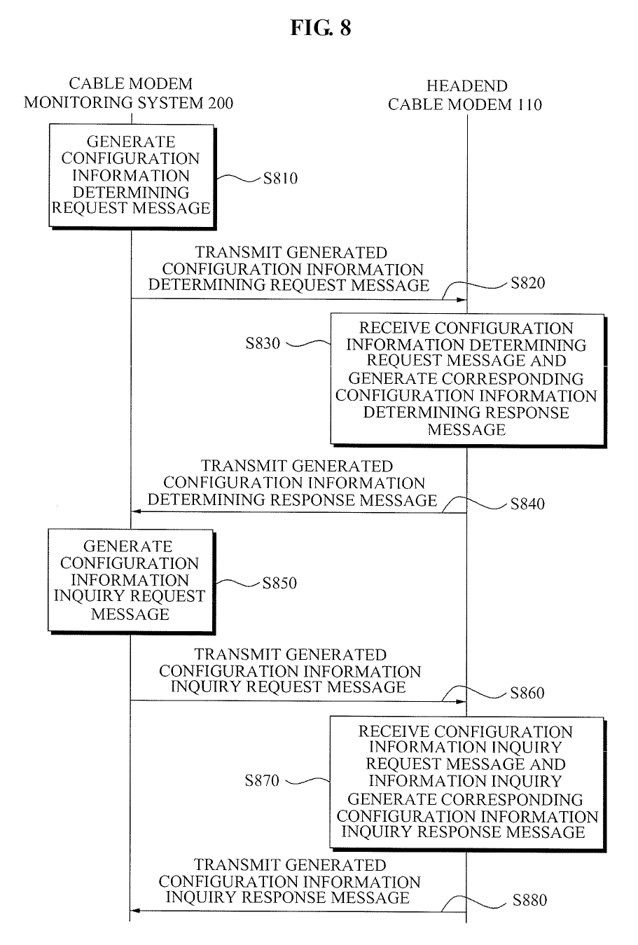

FIG. 8 is a flowchart illustrating a process where a configuration management message is exchanged between a headend cable modem monitoring system 200 according to an exemplary embodiment of the present invention and the headend cable modem.

Referring to FIG. 8, the headend cable modem monitoring system 200 of the present exemplary embodiment of the invention may generate the configuration management message and transmit the generated message to the headend cable modem 110. The headend cable modem 110 receiving the configuration management message may generate the configuration management message (response message) corresponding to the configuration management message, and transmit the generated message to the headend cable modem monitoring system 200.

Specifically, the headend cable modem monitoring system 200 may generate the configuration information determining request message in operation S810, and transmit the generated configuration information determining request message to the headend cable modem 110 in operation S820. Then, in operation S830, the headend cable modem 110 may receive the configuration information determining request message, and generate configuration information determining response message in which the message type information of the configuration management message is the configuration information determining response information. Next, in operation S840, the headend cable modem 110 may transmit the generated configuration information determining response message to the headend cable modem monitoring system 200.

When the configuration information determining request message is a message requiring determination of the configuration information with respect to channel group information and/or flow identification information, a maximum number of bonded channels in an MAC is determined, and index information with respect to the maximum number of bonded channels and flow identification information to be mapped is determined. Specifically, the headend cable modem 110 may generate data, and determine each table index number and each flow identification information as information to be mapped.

Conversely, when the configuration information determining request message is a message requiring determination of the configuration information with respect to the downstream channel transmission rate information, the transmission rate outputted in the MAC is determined, and when the configuration information determining request message is a message requiring determination of the configuration information with respect to flow identification variable information, a basic variable for classifying the determined flow identification information is determined. Specifically, the headend cable modem 110 receiving the message may update the index table with respect to the flow identification information existing in a flow identification information field within the message.

Also, when the configuration information determining request message is a message requiring determination of the configuration information with respect to the flow identification downstream information, output channels with respect to each of the flow identification information are determined. Specifically, a channel group enabling channel bonding output and a channel of the flow identification information other than the channel group may be determined.

Also, when the configuration information determining request message is a message requiring determination of the configuration information with respect to audio/video downstream information, a single channel for outputting audio/video data signal inputted in the MAC is determined, and when the configuration information determining request message is a message requiring determination of the configuration information with respect to the MAC address information of the CPE, the MAC address of the CPE posterior to a platform of the CPE may be determined for the purpose of communication with a router, that is, a matching section of a backbone network.

Similarly, the cable modem monitoring system 200 may generate the configuration information inquiry request message including the configuration information inquiry request information for requesting inquiry of the state information with respect to the headend cable modem in operation S850, and transmit the generated configuration information inquiry request message to the headend cable modem 110 in operation S860. Then, in operation S870, the headend cable modem 110 may receive the configuration information inquiry request message, and generate the configuration information inquiry response message including the configuration information inquiry response information with respect to inquiry response corresponding to the configuration information inquiry request. Next, in operation S880, the headend cable modem 110 may transmit the generated configuration information inquiry message to the headend cable modem monitoring system 200.

The method for monitoring the headend cable modem on the cable network according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to the present invention, there is provided a configuration of a new message which may control and manage the headend cable modem on the cable network.

According to the present invention, there is provided the configuration management message which may manage configuration information for a maximum number of bonded channels of a channel bonding scheme and a flow thereof.

According to the present invention, there is provided the headend cable modem monitoring system which may determine the configuration information of the headend cable modem using the new configuration management message, and inquire state information.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for monitoring a headend cable modem on a cable network, the method comprising:
generating a configuration management message including configuration information for controlling channel bonding of the headend cable modem or state information of the configuration information; and
transmitting the configuration management message to the headend cable modem, and receiving, from the headend cable modem, the configuration management message including response information about the configuration management message,
wherein the configuration management message includes:
a message header unit to include message type information of the configuration management message; and
a message varying unit to include the configuration information and the state information corresponding to the message type information.

2. The method of claim 1, wherein the message type information includes configuration information determining request information for controlling the configuration information, or configuration information determining response information with respect to determination response of the configuration information corresponding to the configuration information determining request information.

3. The method of claim 1, wherein the message type information includes configuration information inquiry request information for requesting inquiry of the state information with respect to the headend cable modem, or configuration information inquiry response information with respect to an inquiry response corresponding to the configuration information inquiry request information.

4. The method of claim 1, wherein the configuration information includes channel group information with respect to a number of channels of a channel group enabling channel bonding of the headend cable modem, flow identification information with respect to a flow identifier for identifying a channel of the channel group, and flow identification variable information with respect to a variable for classifying the channel group.

5. The method of claim 4, wherein the headend cable modem receives the configuration management message to thereby generate data to be transmitted, the data corresponding to where channel bonding is implemented, and maps a table index with respect to the data and the flow identifier.

6. The method of claim 4, wherein the headend cable modem receives the configuration management message to thereby update an index table with respect to the flow identifier.

7. The method of claim 1, wherein the configuration information includes downstream channel transmission rate information with respect to transmission rate determination of a downstream channel.

8. The method of claim 1, wherein the configuration information includes flow identification downstream information with respect to a channel through which a packet is outputted, the packet corresponding to the flow identifier for identifying the channel of the channel group of the headend cable modem.

9. The method of claim 1, wherein the configuration information includes audio/video downstream information with respect to channel information of a data stream where audio/video data is multiplexed.

10. The method of claim 1, wherein the configuration information includes terminal Media Access Control (MAC) address information with respect to a MAC address of a subscriber terminal.

11. The method of claim 1, wherein the message header unit includes subsystem identification information for identifying the headend cable modem.

12. The method of claim 11, wherein the generating of the configuration management message includes determining the subsystem identification information; and determining module identification information for identifying a module.

13. The method of claim 12, wherein the transmitting includes analyzing the message type information from the determined module identification information to thereby transmit the configuration management message corresponding to the message type information, and receiving the configuration management message corresponding to the message type information from the headend cable modem.

14. The method of claim 1, wherein the message header unit includes module identification information for identifying a module included in the headend cable modem, and submodule identification information for identifying a downstream modulation module or an upstream demodulation module when the module is either the downstream modulation module or the upstream demodulation module.

15. The method of claim 1, wherein the message header unit includes configuration information determining number information with respect to a number of determination information of the configuration information included in the message varying unit.

16. The method of claim 15, wherein the message varying unit includes data corresponding to the configuration information according to the configuration information determining number information.

17. The method of claim 1, wherein the cable network is a network based on Data Over Cable Service Interface Specification (DOCSIS) 3.0.
